(19) United States
(12) Patent Application Publication
(10) Pub. No.: US 2002/0019805 A1
(43) Pub. Date: Feb. 14, 2002

(54) Ratchet mortgage

(76) Inventor: Andrew Kalotay, Spencertown, NY (US)

Correspondence Address: Arthur L. Plevy, Esq., Duane, Morris & Heckscher LLP, Suite 100, 100 College Road West, Princeton, NJ, 08540, US

(21) Appl. No.: 09/923,529

(22) Filed: Aug. 7, 2001

Related U.S. Application Data
(60) Provisional application No. 60/224,271, filed on Aug. 10, 2000.

(51) Int. Cl. G06F 17/60

(52) U.S. Cl. 705/38

(57) ABSTRACT

A method for structuring a mortgage having an associated current interest rate based upon a time-varying market interest rate, whereby as the market interest rate declines with time the current interest rate for the mortgage declines and when the market interest rate increases with time the current interest rate remains unchanged. The method includes the steps of: calculating the current interest rate for the mortgage at a first time dependently upon the market interest rate at the first time; and, calculating a reset interest rate for the mortgage at a second time dependently upon the market interest rate at the second time. If the reset rate is less than the current rate, the current rate is reset or updated to the reset rate and the mortgage is operated using the reset current interest rate. If the reset rate is equal to or greater than the current rate, the mortgage is operated using the current interest rate.

### FIELD OF INVENTION

The present invention generally relates to mortgages, and more particularly to an improved type of residential and commercial mortgages.

### BACKGROUND OF THE INVENTION

There are essentially two types of home mortgages conventionally available: fixed rate and adjustable rate (ARM). A fixed rate mortgage has an interest rate which does not change during the entire term of the loan. The interest rate of an ARM is the sum of an index and specified spread, e.g. the yield of a one-year Treasury note and 275 basis points, or 2.75%. The interest rate is reset periodically, e.g. annually. Typically there is a lifetime cap on the interest rate, i.e. a rate that cannot be exceeded, e.g. 10%, along with a period cap and a period floor (together, a period collar), i.e. the maximum allowed change due to a single reset, e.g. ±2%. When the rate is reset, the amortization of the remaining principal is adjusted accordingly.

The primary appeal of ARMs to home buyers is that at the time of borrowing it costs less than a fixed rate 30-year mortgage. This is because the Treasury yield curve is normally upward sloping. When the yield curve flattens, this effect diminishes and the origination of ARMs tends to wane.

During its life the interest rate of an ARM fluctuates. If the Treasury index rises, the rate can exceed what the fixed rate would have been at the time of borrowing. When rates decline to a level that is attractive by historical standards, borrowers tend to prepay ARMs and “lock in” a fixed rate by refinancing with a fixed-rate mortgage.

While prepayment and accompanying refinancing can advantageously lower a borrower's periodic payments, and occur with both ARMs and fixed-rate mortgages, there are drawbacks. For the borrower, there are typically substantial transaction costs associated with the refinancing, e.g. one percent of the principal amount of the outstanding mortgage. Further, determining when to prepay and refinance is an agonizing decision. A drop in interest rates after a borrower has refinanced leads to prepayer's remorse, since the mortgage could have been refinanced at a lower rate had the borrower waited. Similarly, delaying refinancing and watching rates rise leads to lingerer's remorse, because the borrower has lost the opportunity to refinance the mortgage more cheaply. For the mortgage servicer, i.e. the financial institution that manages the mortgage for an on-going fee, e.g. 0.25%, prepayment results in a loss of revenue. And, investors incur transaction costs associated with reinvestment. The main beneficiaries of this process are the mortgage originators, and the related infrastructure, e.g. brokers and legal counsel.

Accordingly, it is an object of the present invention to provide a mortgage that eliminates the need for refinancing or prepayment when interest rates decline, and remains attractive to prospective borrowers.

### SUMMARY OF INVENTION

A method for structuring a mortgage having an associated current interest rate based upon a time-varying market interest rate, the method including the steps of: calculating the current interest rate for the mortgage at a first time dependently upon the market interest rate at the first time; calculating a reset 1interest rate for the mortgage at a second time dependently upon the market interest rate at the second time; and, if the reset rate is less than the current rate, resetting the current rate to the reset rate and operating the mortgage using the reset current interest rate; and, if the reset rate is equal to or greater than the current rate, operating the mortgage using the current interest rate; whereby, when the market interest rate declines with time the current interest rate for the mortgage declines and when the market interest rate increases with time the current interest rate remains unchanged.

### BRIEF DESCRIPTION OF THE FIGURE

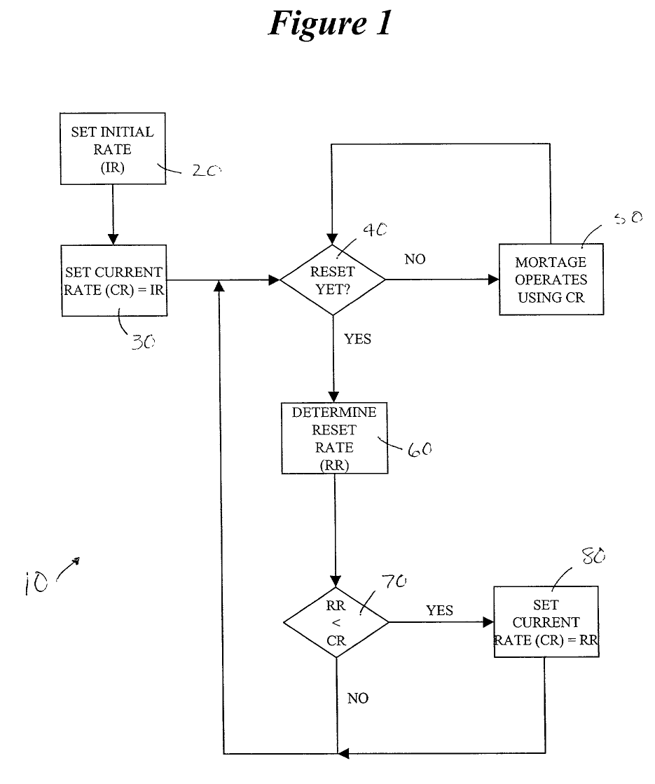

Various other objects, features and advantages of the invention will become more apparent by reading the following detailed description in conjunction with the diagram, which is shown by way of example only, wherein FIG. 1 illustrates a preferred method for structuring a mortgage according to the present invention.

### DETAILED DESCRIPTION OF THE PRESENT INVENTION

A Ratchet Mortgage according to the present invention is a surrogate for a conventional fixed-rate mortgage or ARM. In actuality it behaves like a sequence of fixed rate mortgages, each prepaid and refinanced over time as interest rates decline. Its salient feature is that while the resulting mortgage payments can decline over time, they cannot increase. Accordingly, features unattractive to borrowers for both the ARM and fixed-rate mortgage are advantageously eliminated while features attractive to them are advantageously retained.

For the borrower, a Ratchet Mortgage according to the present invention advantageously eliminates transaction costs associated with repeated refinancings. For the mortgage servicer, it advantageously avoids the truncation of management fees resulting from prepayments due to refinancings.

Although from a purely structural perspective a Ratchet Mortgage is similar to an ARM, its motivation and behavior are fundamentally different. From the borrower's perspective the attraction of an ARM is the low initial rate, while the attraction of a Ratchet Mortgage is the avoidance of subsequent refinancing costs while retaining the ability to benefit from declining interest rates.

As with an ARM, the interest rate of a Ratchet Mortgage is formula-based, although the index can be long-term in nature, e.g. a 30-year Treasury note plus 2.75%. The rate is periodically reset, but only downward. Consequently over time Ratchet Mortgage payments can decline, but not increase.

The Ratchet Mortgage structure can be used for the residential and commercial mortgage markets, in both insured and uninsured forms. Moreover, pass-through securities and related derivative instruments such as CMOs can be designed using pools of Ratchet Mortgages.

Referring now to FIG. 1, therein is illustrated a preferred method 10 for structuring a mortgage according to the present invention. According thereto, when a prospective borrower decides to enter into a mortgage, an initial rate (IR) for the mortgage is set 20. The initial rate is set in the same manner as a conventional ARM mortgage, e.g. identifying an index such as a 30-year treasury note and an appropriate spread. A current rate (CR) from which payments and amortization of the mortgage is calculated is set equal to the initial rate 30. The mortgage operates in the same way as a conventional ARM using the calculated payments 50.

Depending upon design criteria, the mortgage interest rate (CR) is considered for resetting at certain specified times 40. These specified times can be periodic in nature, e.g. annually, quarterly, monthly, or can be triggered upon occurrence of a particular event, e.g. the index value decreasing by more than a threshold value, e.g. 0.25%, 0.5%, or the moving average of the index value decreasing by more than a threshold value.

When it is determined that the mortgage should be considered for resetting 40, a reset rate (RR) is calculated 60 using the then current index rate and the prespecified spread from the reset formula. It is then determined whether the rate resulting from the reset formula is lower than the current rate 70 (RR<CR). If the reset rate is not lower than the current rate, then the mortgage continues to operate using the current rate 50. If the reset rate is lower than the current rate, the current rate is reset to the reset rate 80. New payment and amortization values are calculated using the reset rate and the mortgage operates using the reset rate 50 which is now the current rate.

In a particularly preferred form of the present invention, these steps 30-80 are performed in an automatic manner using a suitable computing system which includes a suitable database for storing information related to the borrowers and mortgages being managed.

In another embodiment of the present invention, the current rate may be set, or reset, to the reset rate only if the difference between the current rate and reset rate exceeds a threshold value, e.g. 0.5. Further, the spread used in calculating the initial rate and reset rate, steps 20, 60, may be the same or different, e.g. the spread used in calculating the reset rate may fluctuate or be based upon the spread used in calculating the initial rate.

Although the invention has been described and depicted in a preferred form with a certain degree of particularity, it is understood that the present disclosure of the preferred form, has been made only by way of example, and that numerous changes in the details of construction and combination and arrangement of parts may be made without departing from the spirit and scope of the invention as hereinafter claimed. It is intended that the patent shall cover by suitable expression in the appended claims, whatever features of patentable novelty exist in the invention disclosed.

We claim:

1. A method for structuring a mortgage having an associated current interest rate based upon a time-varying market interest rate, said method comprising the steps of:
calculating said current interest rate for said mortgage at a first time dependently upon said market interest rate at said first time;
calculating a reset interest rate for said mortgage at a second time dependently upon said market interest rate at said second time; and,
if said reset rate is less than said current rate, resetting said current rate to said reset rate and operating said mortgage using said reset current interest rate; and,
if said reset rate is equal to or greater than said current rate, operating said mortgage using said current interest rate;
whereby, when said market interest rate declines with time said current interest rate for said mortgage declines and when said market interest rate increases with time said current interest rate remains unchanged.
